(19) United States
(12) Patent Application Publication
(10) Pub. No.: US 2009/0056487 A1
(43) Pub. Date: Mar. 5, 2009

(54) FASTENER FOR RELEASABLE BINDING OF PLURAL ITEMS OF VARIOUS SIZES AND NUMBER WITH ADJUSTABLE TENSION

(76) Inventor: Yangpian Chiu, Kaohsiung (TW)

Correspondence Address: DANIEL B. SCHEIN, PH.D., ESQ., INC., P. O. BOX 68128, Virginia Beach, VA, 23471, US

(21) Appl. No.: 11/936,070

(22) Filed: Nov. 6, 2007

(30) Foreign Application Priority Data
Aug. 29, 2007 (TW) 096132115

(51) Int. Cl. F16H 1/04

(52) U.S. Cl. 74/422

(57) ABSTRACT

A fastener device is disclosed for binding together items of varying size and number in a releasable fashion. The binding tension is adjustable. A flexible elongated gear or rack is connected at a first end to a rotational gear and rack guide housing. The gear housing includes guide apertures for passing the second end of the rack through the gear housing for engagement with a round gear or pinion mounted in the housing wherein teeth of the pinion engage the teeth of the rack. The pinion is operatively connected to an adjustment wheel or lever that can cause rotation of the pinion. A pawl operatively connected to the gear housing operatively engages either the rack or the pinion to block relative movement of the pinion and the rack when the rack and pinion are engaged. Optional spring tensioning of the pawl can limit maximum tension of the binding and/or permit rapid release of the binding without damage to the device and/or the items being bound together. The flexible rack may be formed with a curve to facilitate insertion of the second end into the gear housing. In an optional embodiment, the second end of the rack may be inserted into the gear housing and include a stop flange to keep the rack being pulled out of the gear housing.

### PRIORITY

This application claims priority of Taiwan Patent Application Number 096132115, filed Aug. 29, 2007, which is incorporated herein as if reproduced in full below.

### FIELD OF THE INVENTION

The present invention relates to devices for releasable binding of multiple items of varying number and size with adjustable tension, and particular embodiments relate to devices for tying hair for style and practical reasons.

### BACKGROUND

Many different types of fasteners are used to tie objects together, with the simplest devices being for example wire pieces, string, elastic and/or rigid bands, clips, netting and bags. Such devices suffer from varying deficiencies, for example one can't alter the tension, number or size of items bound together without cutting and destroying the fastener, or by tedious untying and retying. Also, rubber bands or other devices might damage the items being tied together. For example, conventional hair rings, hair clips, and elastic bands cannot be easily adjusted when binding together hair, and often damage or breakage of the hair results from excessive tightness, movement or pulling of the tying device or hair, and/or the rings or clips fall off due to insufficient grip. Such prior art hair ties also cause headaches and other injuries. Also, when a prior art hair tie fails, tying the hair all over again causes a waste of time and effort.

Plastic binding strips are available that have a ratchet mechanism at a first end and at least one side of a flexible strip has gear teeth. Upon insertion of the second or opposite end of the strip into the ratchet mechanism to form a loop, pulling of the second end with respect to the ratchet mechanism will cause the loop to shrink. The size of the opening in fasteners for surrounding items to be bound together can be referred to as the “bite” of the fastener, wherein the bite refers to the area surrounded by the fastener. The size and shape of the bite of a fastener may vary depending on the shapes of the items bound thereby. With respect to conventional plastic binding strips, teeth on the flexible strip engage the ratchet mechanism to prevent the bite from getting bigger (e.g., to prevent the fastener from becoming loose when binding objects together). Thus, with such devices, the bite size can be reduced, but not enlarged. Such binding strips are even used by some police departments for restraining the hands and/or feet of prisoners. However, the tightness of such plastic binding strips cannot be adjusted downward (e.g., the bite cannot be made bigger), so the strips can only be used once before being disposed. Such ratchet binding strips also pose a danger as they must be cut off if too tight because the bands can cut into the skin, and there is a danger of reducing or stopping blood circulation due to an undesired tourniquet effect that could cause serious injury and even require amputation. If a child or animal were to have such a ratchet strip placed around the neck, there is a risk of death when tightened, particularly if there are no scissors or suitably sharp object immediately available to cut off the device. Even adults could be harmed or killed by such ratchet fasteners.

Thus, there exists a need in the art for a fastener for releasable binding of plural items, wherein the items to be bound together can be of various number and/or sizes, and wherein the size of the bite and binding tension is adjustable There is also a need for such a fastener that reduces the risk of accidental strangulation or tourniquet action.

### SUMMARY OF THE INVENTION

The adjustable fastener of the present invention solves the safety and adjustability problems of prior art binding devices, while also eliminated waste by being reusable. In an embodiment, a fastener device includes a flexible tying member or rack that has a rack gear. The rack gear has a first end that is operatively connected to a pinion gear housing. The pinion gear housing has a passage that can accommodate movement of the rack gear therethrough. The rack has a second end that can be inserted into and through the rack gear passage of the pinion gear housing. At least a portion of a pinion gear is mounted in the pinion gear housing. The rack gear passage is situated in the pinion gear housing and shaped so as to permit engagement of at least one of the teeth of the rack gear with at least one of the pinion gear teeth when the second end of the rack is inserted in or through the rack gear passage in the pinion housing. A pawl is operatively connected to the pinion gear housing so as to have a first position that permits relative movement of the rack gear with respect to the pinion gear. The pawl has a second position that prevents relative movement of the rack gear portion that is engaged with the pinion, creating a fixed bite size when the pawl is in the second position. In an alternative embodiment not shown, the pawl may be operatively connected to the pinion gear so as to permit or stop respective movement of the pinion gear and rack gear.

In an embodiment, the fastener has a minimum bite size. The minimum bite size is accomplished in an embodiment by the rack gear teeth being located a desired distance from the rack first end, wherein the rack first end is operatively connected to the gear housing; thus, a portion of the rack proximate to the first end of the rack is shaped so that it cannot engage the pinion and/or pawl when the second end of the rack is inserted in or through the rack gear passage in the pinion gear housing. Therefore, the fastener bite cannot be made smaller or if the bite is made smaller there is no resistance in the gear housing to increasing the bite. Alternatively, a portion of the rack proximate to the rack first end will have a shape that bars it from entering the gear housing passage, setting a minimum bite size for the device.

In an embodiment, the pinion gear is operatively connected to an adjustment wheel or lever. Movement of the adjustment wheel or lever causes the pinion to move. Movement of the pinion when the pinion is engaged with the rack gear teeth will cause the bite of the fastener to decrease or increase (i.e., moving the adjustment wheel adjusts the tightness of the fastener). In an embodiment, the adjustment wheel is located outside of the housing for ease of access, and in another embodiment, a portion of the pinion extends outside of the gear housing, permitting one to directly manipulate the pinion to adjust bite and tension. In another embodiment, the pinion gear and an adjustment wheel share a common axis, with the pinion wheel at least partially enclosed by the gear housing while the adjustment wheel is situated outside of the gear housing. A pawl is operatively connected to the gear housing and the pinion wheel and/or the adjustment wheel to selectively permit or block bite and tension adjustment. In an embodiment, the pawl is biased to a first position that prevents rotation of the pinion. In order to permit rotation of the adjustment wheel and/or pinion, the pawl may be pushed to a second position by a user's finger. However, in an embodiment, when sufficient tension is placed by the rack on the pinion gear, the teeth of the pinion gear or adjustment wheel in contact with the pawl will cause the pawl to move from the first position to the second position, thereby preventing the fastener from exceeding a predetermined tension.

Thus, in comparison to prior art devices, the present invention is safer, more cost effective, more comfortable for the user, and reusable, with consequent benefits, for example, the present invention reduces environmental waste. Further, since fasteners of the present invention can be reused many times, it becomes worthwhile to make the gear housing of more expensive and sturdy materials, as well as to make the housing in attractive shapes and with attractive decoration to suit various users and uses. The rack may also be formed of a more expensive but more attractive material, and optionally the rack may be connected at its first end to the gear housing by an attractive chain, string or rope, and optionally another chain, string, or rope can be attached to the second end of the rack and pass through the rack gear passage in the pinion gear housing so as to facilitate insertion of the rack second end into the rack gear passage in the pinion gear housing.

There has been outlined, rather broadly, significant features of the invention in order that further details of the invention that follow may be better understood, and in order that the present contribution to the art may be better appreciated. The subject matter of the claims is supported by any portion or portions of the specification, whether in the summary, brief description of the figures, description of further details of the invention, the figures, the original claims, and/or related art incorporated by referenced.

### BRIEF DESCRIPTION OF THE DRAWINGS

FIG. 1 is an exploded perspective view an embodiment of an adjustable and reusable fastener of the present invention, wherein the relative dimensions of each part and of the parts to one another are not necessarily to scale.

FIG. 2 is a perspective view of the fastener of claim 1 in assembled form.

FIG. 3 is a cross sectional side elevation view of the gear housing, showing cross sections of the pinion gear, the adjustment wheel, pinion axle, and rack.

FIG. 4 is a perspective view of the fastener of claim 2 with the rack inserted into the gear housing so as to create an encircled space or “bite.”

FIG. 5 is a partial cross sectional side elevation view of an alternative rack of the present invention in which the rack has engagement mechanisms to connect portions of the rack to each other.

FIG. 6, is a top elevation view of the rack of FIG. 5 incorporated into a fastener such as that illustrated in FIGS. 1-3.

### FURTHER DETAILED DESCRIPTION OF A PREFERRED EMBODIMENT OF THE INVENTION

Further details of certain embodiments of the present invention will now be described with reference to the drawings, which are provided as illustrative examples of the invention so as to enable those of ordinary skill in the art to practice the invention. The figures and further details provided are not meant to limit the scope of the present invention, but to be exemplary. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

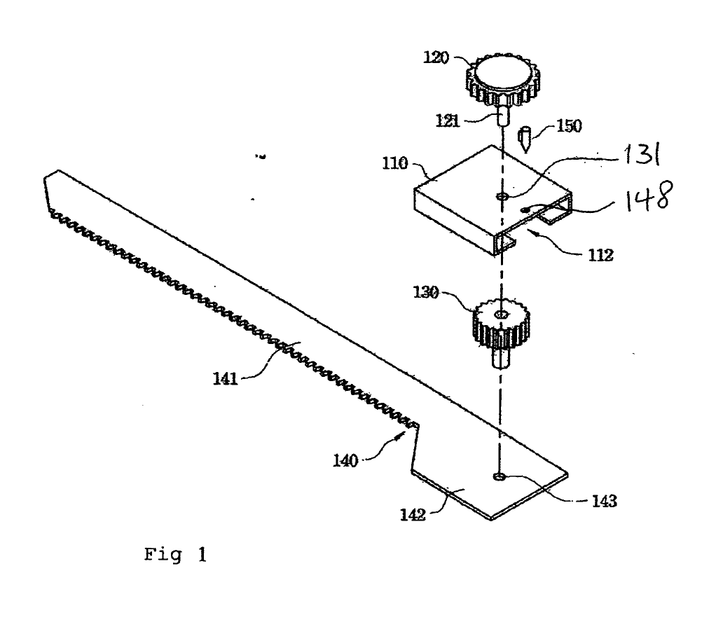

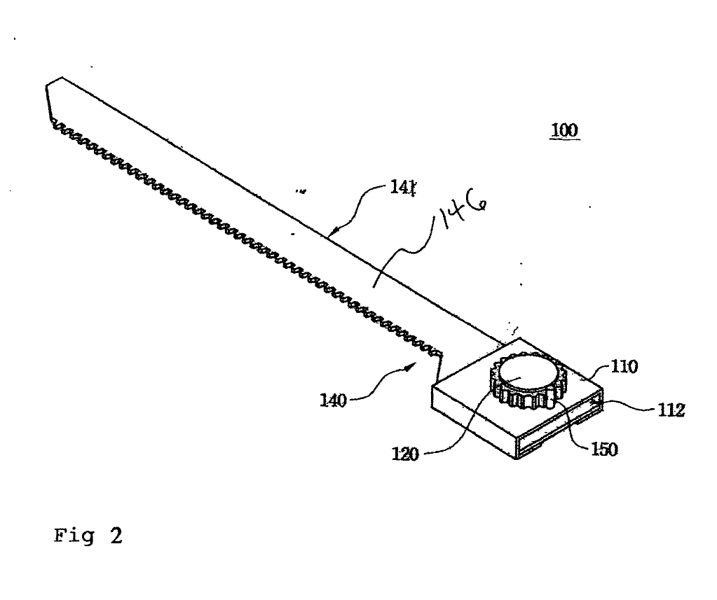

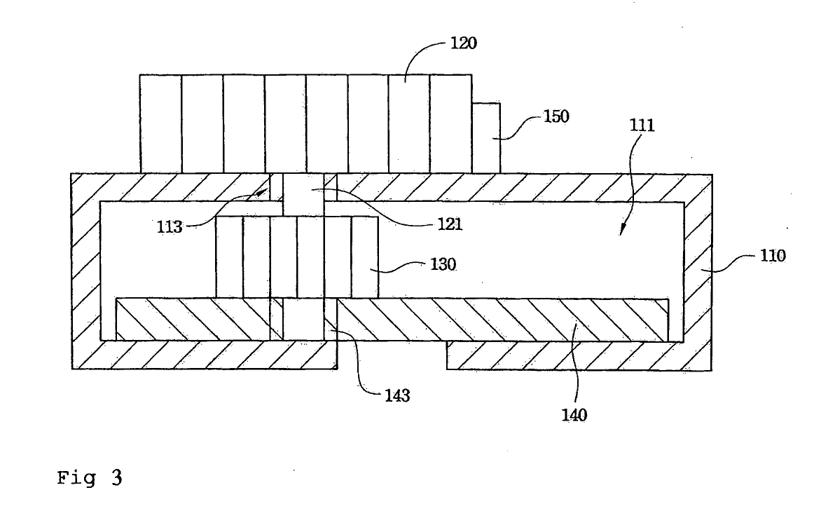

Referring to FIGS. 1-3, an exemplary fastener or tying apparatus 100 of the present invention is illustrated. Fastener 100 may be used to tie hair for example. To facilitate description reference is made to the following table of exemplary part names and corresponding numbers.

| | |
|---|---|
| 100: Tying Apparatus or Fastener | 110: Casing or Pinion Gear Housing |
| 111: Hollow space or Rack Gear | 112: Opening for Pinion Gear |
| Passage | Assembly |
| 120: Adjustment wheel | 121: Connection axle |
| 130: Pinion Gear | 131: Adjustment wheel axle hole |
| 140: Long tying member or | 141: Rack second end or free end |
| Flexible rack | |
| 142: Rack first end | 143: Rack mounting or assembly |
| | hole |
| 142a: Reference point on rack gear | 146: Rack gear portion |
| 144: Primary coupling | 145: Secondary coupling |
| 150: Stopping block or Pawl | 148: Pawl hole |

Fastener 100 includes a pinion gear housing or case 110 connected to a first end 142 of flexible rack 140. Rack 140 is connected at first end 142 to housing 110 via connection axle 121 of adjustment wheel 120 that passes through hole 131 in housing 110 and through the center of pinion gear 130, which is in turn mounted in assembly hole 143 (standard journaling techniques and parts, not shown, are used for mounting rotational gears and for operative connection of wheel 120 and pinion gear 130). Pawl 150 controls rotation of wheel 120. Rotation of wheel 120 causes rotation of pinion gear 130 in housing 110 and vice versa. In an embodiment, pawl 150 is biased into a first position to engage teeth in the outer edge of wheel 120 (e.g., via a spring, not shown). By pressing pawl 150 into hole 148, wheel 120 can rotate. The housing and its components are aligned so that the housing serves to guide the rack gear through the apertures formed on opposite sides of the housing and create a substantially cylindrical shape to the coiled device, and thereby creating optimal mechanical mating fit of the moving parts. The device is thus constructed with five basic components that are easy to manufacture and assemble: rack gear 140, pinion gear 130, housing 110, adjustment wheel 120 and pawl 150. For example, the rack gear, pinion gear, housing and adjustment wheel can all be mounted and bound together via a single axle that is rotationally mounted in holes 131 and 143; the pawl is rotationally mounted in hole 148 and spring biased against rotation. Hence, binding tension can be readily adjusted or a maximum tension set with a releasable and easily reusable fastening device that is simple and cost-effective to manufacture.

Rack 140 can be bent so that the second end 141 of rack 140 (e.g., opposite of the first end 142) can be inserted into rack gear passage 111 in pinion gear housing 110. The teeth of rack gear portion 146 engage the teeth of pinion gear 130, so that movement of wheel 120 causes corresponding movement of rack gear portion 146 thereby increasing or decreasing the size of the bite defined by the area encircled by rack 140 (the bite is reduced to the extent that a portion of housing 110 extends into the area encircled by rack 140).

In an embodiment, the shape of the teeth on wheel 120 engage pawl 150 at an angle so that the biasing tension holding pawl 150 upwards to engage the teeth of wheel 120 to prevent rotation of wheel 120 can be overcome by sufficient expansive tension or compressive pressure on rack 140. For example, pulling with sufficient force on rack 140 when it is engaged with pinion 130 can force pawl 150 sufficiently downward into hole 148 so that pinion 130 and wheel 120 can rotate. In another embodiment, pawl 150 is rotationally mounted in hole 148 and has a flange that projects into the teeth of wheel 120. The pawl can rotate in either direction depending on the force applied by a biasing spring holding the pawl flange engaged with the teeth of wheel 120. In either embodiment, a user may release or increase tension on an item or items held by the fastener by applying sufficient force, yet this should not damage the fastener. This is a significant safety benefit when the device is accidentally applied to a limb or the neck, as it will permit removal by pulling with sufficient force. A user may also rotate wheel 120 with sufficient force to overcome the bias of pawl 150 in order to adjust the size and tension of the bite of the fastener. Hence, considerable convenience is obtained as the binding tension of the device can be readily adjusted by the user and the device can be readily detached and reattached by a user in a reusable fashion for a plurality of different applications.

Tying apparatus or fastener 100 can be used as a hair ring that is reusable and easily adjusted during use. Housing 110 can be of metal or plastic (e.g., extruded, stamped or molded), and its reusability makes it cost effective to add decorative features and to use a higher grade of construction material. For example, porcelain, corrosion-resistant metal, and semiprecious and/or even precious jewels may be used. Gears can be formed using more durable materials and gear teeth shapes. A broad range of uses are envisioned, with construction materials and size corresponding thereto. For tying of hair, it is desired that the width of rack 140 be significantly greater than its thickness to facilitate ready bending to the shape of the hair mass while not creating too great of tension on a narrow portion of the hair shafts that can cause breakage of the hair shafts (a common problem with elastic hair ties). For a hair tie, the surfaces of rack 140 should be smooth enough to allow some slippage with respect to the hair without damaging the hair, but still permit the fastener to be easily disengaged. In other embodiments, the surface(s) of rack 140 may have a texture that provides a better grip.

Referring to FIGS. 1 to 3, it can be seen how the alignment of rack 140 in the housing 110 is accomplished so that the rack gear portion 146 will engage the pinion gear teeth in housing 110 when the rack member is coiled upon itself and the free end 141 inserted into the passageway 111 in the housing 110. In the embodiment shown, a rack mounting hole 143 in rack member 140 is aligned along a common axis with adjustment wheel axle hole 131, so that axle 121 passes through the axle hole 131, and into the center of pinion 130. A rotational mount or rivet can be passed upwards through rack mounting hole 143 or the end of axle 121 can be mounted in hole 143 in a fashion that permits rotation of pinion 130 and wheel 120 while ensuring proper alignment of the pinion gear, adjustment wheel 120, the rack gear and pawl 150. Alignment of the pawl is achieved by selective placement of pawl mounting hole 148 in the top of housing 110. The bottom of housing 110 is formed of inward facing flanges projecting from side walls, which in the embodiment shown hold the first end 142 of rack member in place, with rack first end 142 being dimensioned to mate with the bottom of the side walls and flanges of the housing so that the rack gear portion 146 is linearly aligned for engagement with the pinion gear.

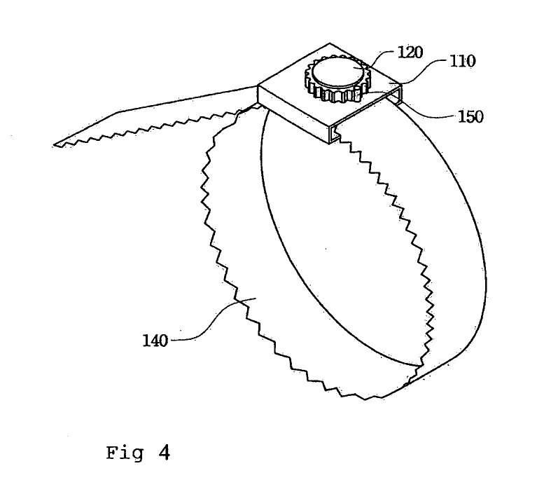

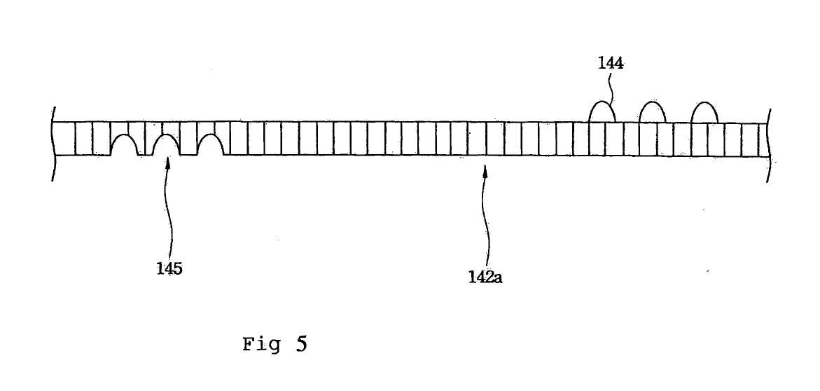

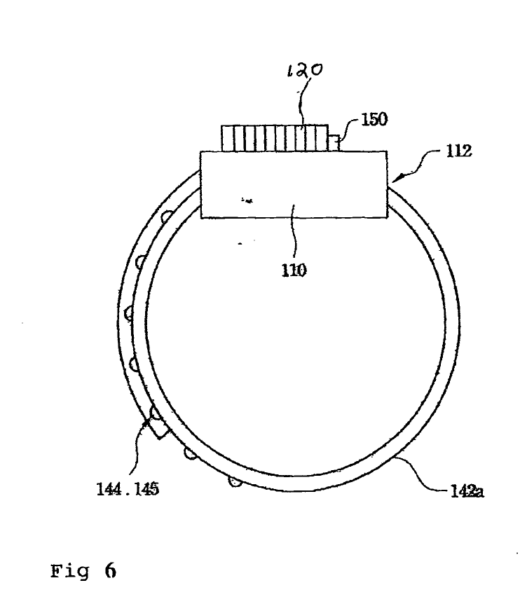

Referring to the embodiment of FIGS. 5 and 6, the excess length of flexible rack 140 can be detachably connected to the outer portion of the rack that it overlaps after coiling (all other features of this embodiment being the same as that of FIGS. 1-4 unless otherwise specified). Using reference point 142a of rack 140, at least one primary coupling 144 (or protrusion) is show on the upper or outer surface of rack 140 (a plurality of couplings is shown). At least one secondary coupling 145 (or detent) is formed on the side of rack 140 opposite to the side having at least one primary coupling 144 (a plurality of couplings is shown with spacing corresponding to that of primary couplings 144). In this embodiment, the primary and secondary couplings are on surfaces perpendicular to the rack gear teeth that engage the pinion wheel 130 in the housing 110. Further, the passage 111 in housing 110 is shaped and dimensioned to permit passage of the portion of rack 140 having primary couplings 144. With the first end 141 of rack 140 connected to housing 110, rack 140 is coiled upon itself and second end passed through passage 111 and extends at a distance from housing 110 depending on the desired bite size of the fastener. A primary coupling can mate with a secondary coupling to prevent the second end of rack 140 from projecting at a tangent from the generally circular shape of the fastener at the point where the second end of rack extends from housing 110. The size and shape of the secondary couplings accommodate the curve of the rack 140 when engaged at its first end and at a second point with the housing 110; the material forming the rack and the primary couplings permits frictional or pressure fit mating of the primary 144 and secondary 145 couplings as seen in the embodiment of FIG. 6, wherein the fastener forms a substantially cylindrical shape and bite of corresponding size and shape. In an embodiment, a first end of flexible rack 140 is connected to housing 110 and the second end coiled about so as to enter and extend through housing 110 via passage 111, wherein the second end is coiled interiorly of the first end. The housing 110 and outer coil of rack 140 conceals the overlapping portions of rack 140 to create a neat appearance. Protrusions 144 and detents 145 are located on the opposite sides of rack 140 so as to permit mating to maintain the neat appearance of a substantially circular band or cylindrical appearance.

The invention is capable of other embodiments and of being practiced and carried out in various ways, and as such, those skilled in the art will appreciate that the conception upon which this disclosure is based may readily be utilized as a basis for the designing of other methods and systems for carrying out the several purposes of the present invention. For example, the present application is based on a translation of Taiwan Patent Application 096132115, from which priority is claimed, but includes alternative language and description in addition to that in the Taiwan application; to the extent any aspect of the invention described or claimed in said Taiwan application is not present herein no waiver of protection or right to claim same is made hereby and Applicant considers the description and claims of said Taiwan application to be part hereof. Likewise, the abstract and claims of this application and that of said Taiwan patent application are a part hereof as if reproduced in full below. Therefore, that the claims be regarded as including all equivalent constructions insofar as they do not depart from the spirit and scope of the present invention.

I claim:

1. A fastener, comprising a housing and a rack member, said rack member having a first end operatively connected to said housing and a rack gear, said rack member having a portion sufficiently flexible to permit bending of said rack member to permit said rack gear to be inserted through a passageway in said housing, wherein said rack member when inserted into said passageway defines an enclosed area, said housing having a pinion gear mounted therein that can operatively engage said rack gear when said rack gear is inserted in said passageway, said fastener further comprising a pawl operatively connected to said pinion gear, said pawl having a first position preventing movement of said pinion gear and a second position permitting movement of said pinion gear, wherein movement of said pinion gear when engaged with said rack gear causes corresponding movement of said rack gear in said passageway, said pinion gear being operatively connected to an adjustment wheel, wherein at least a portion of said adjustment wheel is external of said housing and movement of said adjustment wheel causes said pinion gear to move.

2. The fastener of claim 1, wherein said adjustment wheel and said pinion gear are mounted on a common axis, and said pawl is connected to said housing and biased to engage said adjustment wheel, wherein said pawl can be positioned to prevent or permit movement of said adjustment wheel and said pinion gear.

3. The fastener of claim 2, wherein said adjustment wheel is mounted to the exterior of said housing and said pinion gear is mounted inside of said housing, said adjustment wheel being connected to said pinion gear via an adjustment wheel axle opening in said housing, and wherein said pawl is connected to said housing, wherein said adjustment wheel has gear teeth, and said pawl is biased against the gear teeth of said adjustment wheel, wherein said pawl permits rotation of said adjustment wheel when said adjustment wheel is rotated with sufficient force or when sufficient rotational force is applied to said pinion gear by pulling or pushing of said rack gear engaged with said pinion gear.

4. The fastener of claim 3, wherein said pawl is rotationally mounted on said housing, said pawl having a flange that engages said gear teeth of said adjustment wheel and is biased to permit rotation thereof upon application of sufficient force directly to said adjustment wheel or when sufficient force is applied to said pinion gear by pulling or pushing of said rack gear when engaged with said pinion gear.

5. The fastener of claim 3, wherein a portion of said rack gear that passes through said passageway extends from said housing interiorly of said first end of said rack member.

6. The fastener of claim 3, wherein said housing comprises a material selected from the group consisting of metal and plastic, said adjustment wheel comprises a material selected from the group consisting of metal, plastic and ceramic, and said rack member comprises a material selected from the group consisting of metal and plastic.

7. The fastener of claim 3, wherein said first end of said rack member comprises a rack connecting hole and said rack member is connected to said housing by passage through said hole of said common axle of said adjustment wheel and said pinion wheel.

8. The fastener of claim 8, wherein said rack member first end is dimensioned to linearly align said rack member gear portion for engagement with said pinion gear when said rack connecting hole is axially aligned with said adjustment wheel axle opening.

9. The fastener of claim 1, wherein said adjustment wheel includes a decoration.
